(19) United States
(12) Patent Application Publication
(10) Pub. No.: US 2026/0105288 A1
(43) Pub. Date: Apr. 16, 2026

(54) SEMANTICALLY-STRUCTURED WEBPAGE TEMPLATES USING GENERATIVE MACHINE LEARNING MODELS

(71) Applicant: Webflow, Inc., San Francisco, CA (US)

(72) Inventors: Tristan Kenneth Tarpley, Houston, TX (US); Christine Pham, San Francisco, CA (US); James Matthew Gawarecki, Franklin, TN (US); Jonathan Quach, Markham (CA); Sergie Magdalin, San Francisco, CA (US); Bryant Chou, San Francisco, CA (US)

(21) Appl. No.: 19/357,335

(22) Filed: Oct. 14, 2025

Related U.S. Application Data
(60) Provisional application No. 63/707,158, filed on Oct. 14, 2024.
(60) Provisional application No. 63/707,167, filed on Oct. 14, 2024.

(51) Int. Cl. G06N 3/0475; G06N 3/042

(52) U.S. Cl. CPC G06N 3/0475; G06N 3/042

(57) ABSTRACT

Methods, systems, and apparatus, including computer programs encoded on computer storage media, for generating webpage data. An example method includes receiving request data specifying user requirements for generating a webpage. Based on the user requirements, content data is generated according to semantic similarity. The content data specifies pre-constructed page templates from a content management system, and corresponding section metadata that organizes webpage contents. The prompt data is generated for trained machine learning models. The prompt data includes instructions for generating output data comprising content for populating the pre-constructed page templates based on the section metadata. The prompt data is provided to the trained ML models to obtain output data. Based on the output data, the representation of the webpage is generated by populating the pre-constructed page templates with the output data. An instruction is provided that, when received by the computing device, causes the computing device to display the representation.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather than following predefined rules, ML systems build models based on patterns found in large datasets. These models can then make predictions, classify data, or perform decision-making tasks based on new, unseen data. ML may involve providing input data into a trained model, which processes the provided data to identify patterns or relationships within the data.

ML may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Information retrieval systems typically receive a user query and match the query against an index constructed from a corpus of documents. The index may be created by parsing documents, extracting terms and features, and building data structures that map terms to document locations. Candidate results are identified using lexical signals such as term frequency, inverse document frequency, and field weighting, and are then ranked by relevance scores. ML may be used to automate and improve these stages, including query understanding, document representation, candidate generation, and ranking.

### SUMMARY

This disclosure relates to systems and techniques that enhance user productivity and reduce the learning curve associated with complex web design tools. This can be accomplished by generating multiple webpages in bulk according to the user's request and utilizing one or more generative machine learning models. The output data generated from one or more machine learning models is used to populate respective sections of one or more pre-constructed webpage templates. This fuses output data generated from the one or more machine learning models with one or more pre-constructed webpage templates identified from a content management system (CMS) according to the user request to generate a representation of multiple webpages. The pre-constructed webpage templates stored in the CMS are updated regularly. The techniques described herein further support coherent multi-turn interactions and improve over time through user feedback.

For example, a user (e.g., a site controller) may interact with a user interface (e.g., a chat-based text interface or a multiple-choice selection interface) to submit request data that specifies one or more requirements for generating webpages. The request data may take the form of a text-based user query, data uploaded by the user, or a user selection from a set of provided options. These requirements specified by the request data can include data defining a particular approach to generating multiple webpages, or text-based specifications or a user selection of options that describe webpage characteristics, such as style, theme of one or more webpages, a background color for a webpage, a primary color for a webpage, particular content, tone of the particular content, or a structure or arrangement of multiple contents. The system can then identify content data by evaluating the semantic similarity between the user requirements and the content stored in the CMS. The semantic similarity can be represented by a semantic similarity score measured by the distance among vector features projected into an embedding space. The identified content data, for instance, may include one or more pre-constructed page templates and for each template, section metadata that organizes the webpage content.

The term “section metadata,” as used herein, refers to data that defines the structure and organization of a webpage by specifying its sections and their respective functions. For example, section metadata may specify that a webpage includes a header section with a title and one or more navigation links, a body section containing text and one or more images, a price section presenting multiple pricing options, a testimonial section highlighting user feedback, a footer section with contact information and legal disclaimers, an about section briefly summarizing information associated with the webpage, a FAQ section including answers to a list of frequently asked questions, a contact section summarizes various contact methods associated with the webpage, etc. Section metadata can also define formatting attributes, such as whether a section supports rich media (e.g., embedded video) or dynamic content (e.g., user comments). Section metadata can further include other suitable data specifying the formatting, arrangement, or combination of potential content chunks in the CMS that constitute a candidate webpage.

The system next generates prompt data to serve as input for one or more trained machine learning (ML) models. This prompt data includes instructions for producing output data that populates the pre-constructed page templates according to the section metadata. The prompt data may be derived, at least in part, from the request data. The system provides the prompt data to the trained ML models and obtains the resulting output data. The system then generates a representation of one or more webpages by fusing the output data into the respective sections of the pre-constructed webpage templates. For example, the system may populate multiple webpages by inserting corresponding output data into the templates based on the associated section metadata. In response to the request data, the system can further transmit an instruction to the computing device that, when executed, causes the device to display the representation of the populated webpages.

In one general aspect, this disclosure is focused on a computer-implemented method that includes a set of operations. The operations include receiving, by a server system and from a computing device, request data specifying one or more user requirements for generating a webpage. The operations also include identifying, by the server system and based on the one or more user requirements, content data specifying one or more pre-constructed page templates from a content management system, and for each of the one or more pre-constructed page templates, corresponding section metadata that organizes webpage contents according to semantic similarity. Further, the operations include generating, by the server system, prompt data for one or more trained machine learning (ML) models. The prompt data includes one or more instructions for generating output data including content for populating the one or more pre-constructed page templates based on the section metadata. The operations also include providing, by the server system, the prompt data to the one or more trained ML models, and obtaining, by the server system and from the one or more trained ML models, the output data. Additional operations include generating, by the server system and based on the output data, a representation of the webpage by populating the one or more pre-constructed page templates with the output data. Further operations include providing, by the server system and to the computing device responsive to the request data, an instruction that, when received by the computing device, causes the computing device to display the representation.

One or more implementations may include the following optional features. For example, in some implementations, the content for populating the one or more pre-constructed page templates may include textual content.

In some implementations, the one or more user requirements may include a theme for the webpage. In some implementations, the theme may specify a background color and a primary color for the webpage.

In some implementations, identifying the content data may include embedding a first portion of the request data into a query vector representation in an embedding space, determining a respective semantic similarity score based on a respective distance in the embedding space between the query vector representation and a vector representation for each of content chunks segmented from a multi-modal knowledge base associated with the content management system; and selecting one or more of the content chunks as the content data.

In some implementations, the output data may include textual data, image data, audio data, or video data.

In some implementations, the one or more trained ML models may include a multi-modal encoder and a multi-modal decoder.

In some implementations, the one or more trained ML models may include a large language model (LLM).

In some implementations, the operations may further include receiving, by the server system and from the computing device, a second request data specifying a user interaction with a targeting portion of the representation, and generating, by the server system and based on the output data and the second request data, second prompt data for the one or more trained ML models. The second prompt data may include one or more additional instructions for generating the output data based on the user interaction.

In some implementations, the output data may specify a plurality of candidate outputs for the representation of the webpage.

In some implementations, generating the representation of the webpage may include generating a plurality of representations of the webpage. Each representation included in the plurality of representations of the webpage may be generated by populating the one or more pre-constructed page templates with a corresponding candidate output included in the plurality of candidate outputs.

In some implementations, the operations may further include receiving, by the server system and from multiple computing devices, respective preference data indicating one or more user preferences of each of the multiple computing devices, generating, by the server system, aggregate user preference data based on the one or more user preferences of each of the multiple computing devices; and updating, by the server system and based on the aggregate user preference data, the one or more of the pre-constructed page templates.

The subject described in this specification can be implemented to provide a range of technical advantages, effects, and benefits. For example, the described systems and techniques enable the efficient bulk generation of multiple webpages that are contextually aligned with user requirements. This bulk generation capability reduces manual design overhead, shortens development cycles, and scales webpage production without sacrificing content quality or consistency. To achieve the above-noted benefits, the described systems and techniques overcome limitations of conventional information retrieval systems by grounding ML-assisted responses in a first-party knowledge base that is periodically curated within the CMS and accessed using retrieval-augmented generation (RAG).

Unlike open-ended generative systems that may produce unverified or hallucinated content, the described techniques ensure that generated webpages responsive to user requests are based on authoritative, domain-specific content maintained by the CMS. The system identifies relevant content data to be retrieved from the CMS according to semantic similarity between the request data and the CMS content data in a vector embedding space, which supports nuanced retrieval beyond keyword matching. The retrieved content data can include one or more webpage templates and associated section metadata defining the structure and organization of webpage contents, as described above.

The CMS may maintain multimodal content (e.g., text, images, audio, video) that is segmented into content chunks. Segmenting content enables incremental updates, allowing administrators to add, modify, or deprecate content chunks without requiring a full re-indexing of the knowledge base. This reduces the propagation of stale or outdated content into webpage templates or generated webpages. The CMS can also record up-to-date metadata, source identifiers, and version histories, among other information, to enable retrieval methods that prioritize current content and avoid superseded entries. This ensures that generated webpages reflect the latest standards, policies, or product features.

Further, the system may incorporate user feedback signals (e.g., explicit ratings or implicit engagement metrics) to re-weight retrieval and prompt-generation policies over time. These adaptive updates improve semantic relevance and maintain alignment with evolving user needs, business priorities, and best practices. By combining the RAG pipeline with a recursively updated CMS knowledge base, the system ensures that generated outputs are contextually appropriate and trustworthy for webpage generation.

Referring back to the ML aspect of the described techniques, to replace or populate contents for corresponding sections in one or more webpage templates, the system can generate prompt data for one or more ML models to produce output data (also referred to as ML-generated content data in the following description). The prompt data may incorporate both user-specified requirements (e.g., stylistic or thematic preferences as described above) and contextual data. Contextual data may include metadata associated with the user and the current request, such as workspace identifiers, user data stored in a multi-tenant database, or textual and other content embedded in a webpage currently being edited. The contextual data can also include section metadata retrieved from the CMS according to the semantic relevance of the user requests. The inclusion of contextual data in determining prompt data ensures that ML models generate outputs that are not only structurally aligned with webpage templates (and section metadata) but also tailored to the user's requirements, environment, audience, or project.

The systems and techniques described throughout this disclosure improve the accuracy, relevance, and efficiency of fusing ML-generated content with page templates for webpage generation. This is achieved by grounding prompt data for ML models in both user requirements and contextual metadata. Webpage templates and section metadata are then retrieved based on semantic relevance to user requirements (and optionally contextual data). Data retrieval and/or prompt data generation are then further refined based on user feedback. This improves the accuracy, relevance, and efficiency of fusing ML-generated content with page templates for webpage generation. Grounding prompt data generation, semantic-relevance-based database retrieval, and overall optimization in this manner reduces risks associated with irrelevant or off-brand content and ensures consistency across multiple webpages. Moreover, because the data retrieval process, prompt-generation process, and optimization process can be modular, the system can dynamically adjust one or more of the above-noted modules based on evolving contextual input/context, enabling continuous refinement of generated webpages over periodic iterations.

Moreover, the systems and techniques may further leverage ML to efficiently improve website development with varying levels of process automation in an iterative fashion. For example, a user can type a natural language request asking for adding a five-page marketing microsite to the generated multiple webpages, and the system may generate a prompt data grounded by context data as described for an ML model to generate the corresponding page structures, themed style tokens, component markup, and placeholder media. The build pipeline of the system then compiles these assets, writes them to the artifact repository, and publishes them through the edge delivery layer without requiring the controller to write any code. As another example, when a user requests a redesigned testimonial slider, the system can generate a prompt based on the requests and corresponding context data (e.g., the existing collection fields and reference links) to the ML model to generate an updated component that preserves field binding relationships. The system can efficiently validate the generated markup against the CMS schema, update only the affected bundle, and deploy the component so the new slider renders correctly across all locales without breaking any data-driven pages.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for generating multiple webpages in response to a user request using one or more ML models and a content management system.

FIG. 2 illustrates an example of a system that enables a web experience platform (WEP) for supporting web development using one or more ML models.

FIGS. 3A-3D illustrate a sequence of examples of user interfaces 300 and 350 for generating one or more webpages using one or more machine learning models and a content management system.

FIG. 4 illustrates a flow chart for an example of a process for generating multiple webpages in response to a user request using one or more ML models and a content management system.

In the drawings, like reference numbers represent corresponding parts throughout.

### DETAILED DESCRIPTION

This disclosure describes bulk generation of webpages using one or more ML models and a content management system (CMS). In operation, the system receives request data from a computing device, where the request data specifies one or more user requirements for generating webpages. Based on this request data, the system identifies one or more webpage templates and their corresponding section metadata according to a measure of semantic similarity within a vector feature space. For example, the system can identify webpage templates and section metadata using retrieval-augmented generation (RAG). The system then generates prompt data that specifies instructions for one or more ML models to produce content consistent with the section metadata and other contextual data. The generated content is inserted into the corresponding sections of the webpage templates, thereby producing a representation of multiple webpages in response to the user request. Finally, the system provides one or more instructions to the computing device that, when executed, cause the device to display the generated webpage representation in response to the request data. This process automates the creation of a website in a way that the content is both thematically consistent and structurally constrained by the schema requirements of the content management system.

This disclosed systems and techniques improve various aspects of webpage development, such as creating websites within an authoring environment using ML. Generally, the user can interact with a software application on their client device that allows users to create, publish, and modify digital content without any coding experience. Users interact with this software application manage websites, manage website content, and generate new website content regardless of technical expertise or skill level. The software application can provide a graphical user interface (GUI) on the client device that enables the user to create, edit, modify, and publish webpage content online.

The techniques described herein also improve upon contextual guidance provided by code generation systems. For instance, instead of merely retrieving information from a fixed knowledge base to guide a user's manual actions, the present disclosure describes a system that automates the generation of webpage creation in deploying a website. While some code generation systems utilize a passive knowledge base for informational retrieval, the disclosed systems leverage the CMS as an active, executable framework. This is achieved by constructing a prompt for an ML model that is specifically constrained by a set of web development tools and tasks that are native to the CMS. The system's awareness of the available tools, their development history, prior usage patterns, and the multi-tenant architecture of the platform allows it to generate a highly specific set of instructions for the ML model, moving beyond informational guidance to automated action.

The systems and techniques also leverage prompt construction techniques distinct from some code-generation platforms or “design-to-code” platforms, which typically generate code artifacts (e.g., HTML, CSS) in a relatively unconstrained context. Such platforms often lack deep awareness of the complex rules, schema, and historical context of a specific, pre-existing production environment, such as a multi-tenant CMS. In contrast, the prompt construction processes described herein are uniquely informed by a confluence of data sources. This includes the user's current visual context (e.g., a portion of the webpage the user is viewing and interacting with) and the current, pre-modification state and configuration of the specific webpage. The data sources also include the architectural and historical constraints of the underlying CMS, including the specific web development tools and tasks available to a particular user account and compatible with the target webpage. This multi-contextual awareness enables a high degree of automation within a complex environment, ensuring that the ML-generated code update segment is not only responsive to the user's natural language request but is also guaranteed to be compatible, executable, and consistent with the production environment, thereby avoiding the risks associated with deploying code generated in an isolated context.

Section metadata described herein generally refers to structured data that defines the selection, arrangement, and functional roles of different sections within a webpage. It provides a blueprint for how content is organized and displayed, including the order of sections, the types of content supported by each section, and the interrelationships (e.g., hierarchical order) among sections. In practice, section metadata can operate as a set of instructions or constraints that guide the generation or population of webpages using content generated from ML models and corresponding webpage templates. By doing so, it ensures that generated content is not only semantically relevant but also properly aligned with the design and structural features of webpage templates. In some implementations, the user can be provided with a set of section arrangements derived from the section metadata for selection before and/or after the generation of multiple webpages.

In some implementations, section metadata is determined from user inputs, e.g., provided through request data. A user may specify requirements via a multiple-choice selection interface or a natural language query. For instance, the user may request “a marketing landing page with one or more theme-related images, a pricing table, and customer testimonials.” Based on this input, the system identifies section metadata that corresponds to a header section with media content, a pricing section with multiple price tiers, and a testimonial section highlighting user feedback. These selections are then arranged in a defined order to produce a coherent webpage structure.

Section metadata may also be pre-linked to multiple templates stored in the CMS. In such cases, each theme or topic (defined semantically by keywords in the CMS in a vector feature space or embedding space) is associated with one or more template pages, each of which has a pre-established section arrangement. For example, the keyword “sportswear” may be associated with templates that include sections such as a product grid, a shopping cart summary, and a promotional banner. When the user provides request data that references the “sportswear” keyword, the system retrieves candidate templates and their associated section metadata, combines them in various ways determined by user requests, and generates a preview of possible webpage structures for user selection. The user then reviews and confirms the desired section arrangement before the final generation step.

In some implementations, the user may also be provided with another round of preview of generated webpages with different section arrangements for review and confirmation. This pre-linking between webpage templates and section metadata can evolve over time based on new training data, updated industrial trends, and user feedback. Additionally, the system may further refine its associations or links between keywords, webpage templates, and/or section arrangements on the CMS based on new training data, updated industry trends, and/or user feedback. This allows the system to refine and update content data and metadata stored in the CMS such that the system can identify webpage templates and section metadata in response to user requests efficiently and accurately.

In other implementations, section metadata is updated and/or inferred from a user's historical behavior or historical data stored in a multi-tenant database for the user. For example, if a user frequently builds event registration pages that include a countdown timer, an agenda section, and a speaker bio section, the system can learn this preference and automatically prioritize similar section arrangements in future webpage generations. This approach personalizes the generation process, reduces repetitive manual input, and aligns the generated webpages with the user's established design patterns.

Section metadata may also be derived from the current context in which the user is working. If the user is editing an existing webpage, the system can analyze the content and structure of that page to infer metadata for additional pages. For example, if the current page contains a news article with a featured image, headline, and body text, the system can infer that related pages should maintain a similar structure, potentially with variations such as “related articles” or “archived posts” sections. Likewise, if the user is building a page from scratch, the system can infer section metadata from minimal cues, such as a requested theme (“travel blog”) or functional requirement (“sign-up page”). The above-noted inference can occur at the CMS level, where the system performs semantic analysis based on the user's request and the metadata associated with the current page or section that the user is working on when sending the request. The system can directly determine section metadata that is above a level of semantic similarity with the user request and its metadata. Alternatively, the system can determine section metadata linked to one or more pre-determined keywords stored in the CMS that are semantically similar to the user's request and its metadata.

To identify content data from the CMS according to request data, the system can modify user requests using various techniques. For example, a user can provide an initial or original request captured from a graphical interface, for example, a chat panel or other ML interface. The system generates an updated query by modifying the initial query based on context data, such as workspace context, user historical data, or other relevant context data. Refinement can include text normalization, disambiguation of element names using the context, insertion of project-type or layout terminology, skill-appropriate templating so that the retriever and the model receive task-aligned input, among others. Conversation threading and history tracking may be used so that follow-up questions inherit context without re-specifying prior details.

A workspace context specifies information describing the state of an application at or around the time a user submits a baseline query. The workspace context may identify this state by specifying various types of information, such as the active page or route, an element or component selection, a component hierarchy snapshot, currently visible panels and settings, responsive breakpoints, recent authoring actions, a project-type label indicating the class of site being developed, among others. The workspace context can further include user-specific attributes such as a role or skill tier determined from historical interactions to tailor the level of detail in responses. Context data may further be obtained from a client-side software development kit (SDK), from server-side session state, or from both. In privacy-aware deployments, the collection process can redact user content while retaining structural identifiers sufficient for retrieval and answer construction.

The CMS stores multiple content chunks, which can be pre-determined and/or pre-grouped according to semantic keywords or topics. In some implementations, those keywords and topics stored in the CMS are pre-linked to one or more different themes. Each content chunk in the CMS is embedded to produce a vector representation in a vector feature space stored in one or more vector databases. At runtime, the system causes the CMS to retrieve data (e.g., webpage templates and section metadata) that is semantically similar to the updated query drives retrieval in the vector feature space.

After identifying the content data (including webpage templates and the corresponding section metadata that organize webpage content) the system generates prompt data for one or more trained ML models. The prompt data is determined based on the request data and, optionally, additional context data such as workspace context data or user historical context data. The prompt data includes one or more instructions for generating output data, where the output data provides content for populating the one or more pre-constructed page templates according to the section metadata. Because the prompt data is generated not only from user requests but also from historical and contextual data, and because it is aligned with section metadata retrieved through RAG, the ML-generated output is grounded in ample context beyond the immediate user input. This grounding improves the accuracy, relevance, and consistency of the ML-generated content used to populate the respective sections of the webpage templates.

Referring back to the RAG and CMS described above, the information retrieval techniques disclosed herein are directed to improvements to problems that uniquely arise in computer-related technology. As described herein, the techniques improve how networked computing systems retrieve and serve information under accuracy and latency constraints using specialized data structures and machine operations. This operates on machine-generated signals (e.g., workspace context captured from application state, content chunks with up-to-date metadata, high-dimensional vector representations stored in one or more vector databases) and applies computer-implemented processes (e.g., semantic similarity search, query expansion, prompt assembly) that condition ML models on retrieved passages and section metadata. These steps improves the functioning of the computer by reducing off-topic results, enforcing recency via CMS-managed updates, and meeting a defined end-to-end time threshold from query receipt to UI display. Manual analogs of these operations result in a fundamentally different process.

For instance, a person cannot observe and identify context data for webpage generation (e.g., workspace context, historical context, or other context data) within a specified time period (e.g., less than three seconds), compute nearest neighbors over multimodal embeddings, or orchestrate model routing and caching to satisfy timing imitations associated with the distributed services. The operations involved in the disclosed information retrieval techniques disclosed herein, therefore, address problems unique to computerized information retrieval (context loss, staleness, and scale) and constitute a specific improvement in the operation of computer systems.

Moreover, the information retrieval techniques disclosed herein involve elements specific to computer-related technology, such as vector databases and RAG, to generate information outputs. A vector database transforms heterogeneous source content into machine-optimized representations that enable sub-second retrieval for prompt construction and retrieval-augmented generation. Raw documents may be segmented into content chunks and passed through an embedding model that maps each chunk into a high-dimensional numeric vector whose coordinates encode semantic relationships. The database persists these vectors in specialized indexes, such as graph- or quantization-based nearest-neighbor structures with cache-aligned layouts, precomputed centroids, and distance metrics. A refined query can be embedded once and matched against millions of candidates in time budgets suitable for interactive use. Each stored vector is keyed to a source passage, up-to-date metadata, and version identifiers so the retriever can return current and authoritative chunks that can be injected into an ML prompt without additional parsing.

Data transformations involved in generating embeddings for storage in a vector database make them distinct from mental steps used by humans in storing information. Embeddings are opaque numeric arrays, and similarity search requires parallel numeric kernels over high-dimensional spaces, and the ranking policies that trade recall for latency depend on index statistics and hardware locality. Accordingly, the transformed format of embeddings and their retrieval from a vector database using RAG represent a computer-specific optimization that enables the disclosed information retrieval techniques to supply relevant context to ML models at speeds no manual process could achieve (e.g., within three seconds).

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. ML systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a ML system. Examples of models include ML models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform data transformation, retrieve content from a content management system, initiate ML inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Extensible Markup Language (XML), proprietary markup), enabling programmatic generation of data containers and enforcement of structural consistency across instances. At runtime, the system may validate input data against the schema to ensure compliance and may utilize the schema to automatically bind data values to corresponding fields or locations of a webpage.

As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the ML techniques disclosed herein may be provided to augment, streamline, and/or improve various aspects of a web experience platform that allows users to perform various types of actions relating to website development (e.g., access, design, develop, build, access, manage, analyze). Through use of ML, the techniques disclosed herein may allow users to generate website or webpage content that conforms to structure and schema of a designated webpage. For example, in a ML-enabled web experience platform, when a user requests for changes or modification to components of a webpage, the ML can be configured to create new text, images, and other relevant content based on the user text, prompt, selection, or other input provided by the client device.

Implementations of the present disclosure are described in further detail herein with reference to the creation of content for webpages. In some implementations, the techniques described in this present disclosure are applicable to the creation of content for other application, such as applications, emails, product designs, brochures, or other products, to name some examples.

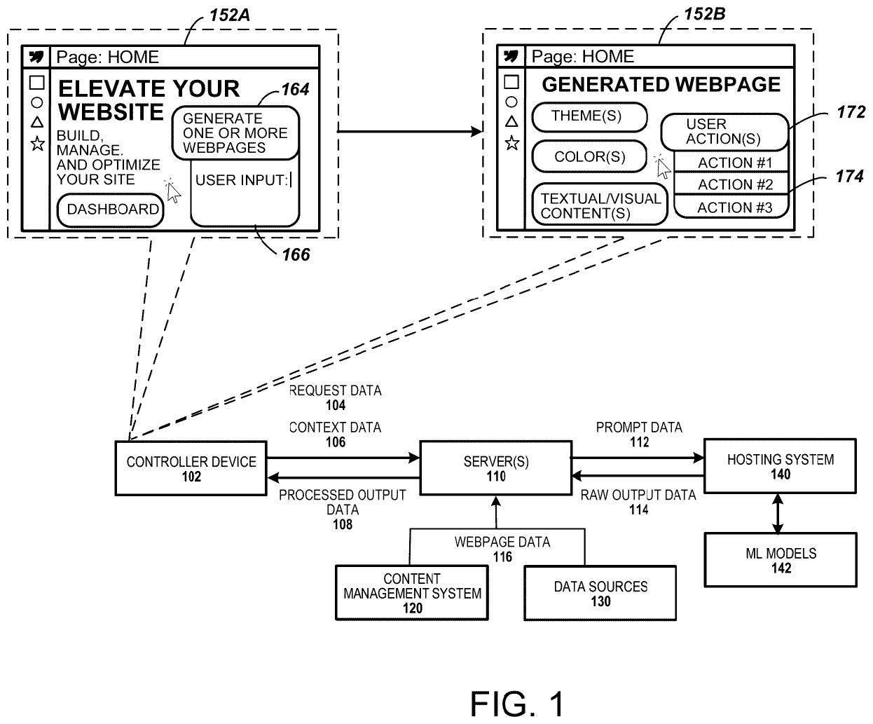

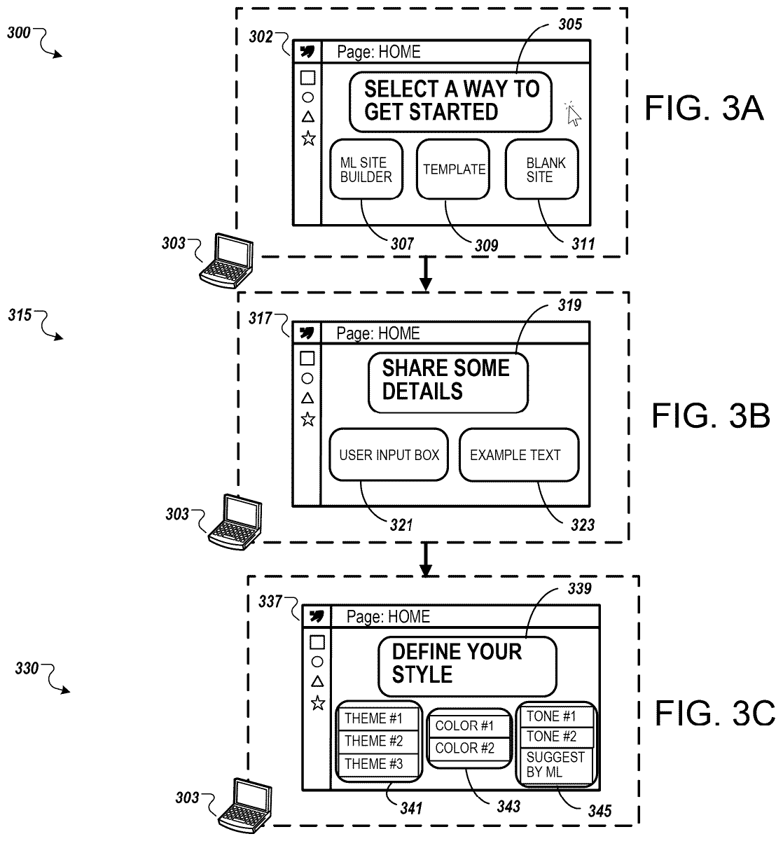

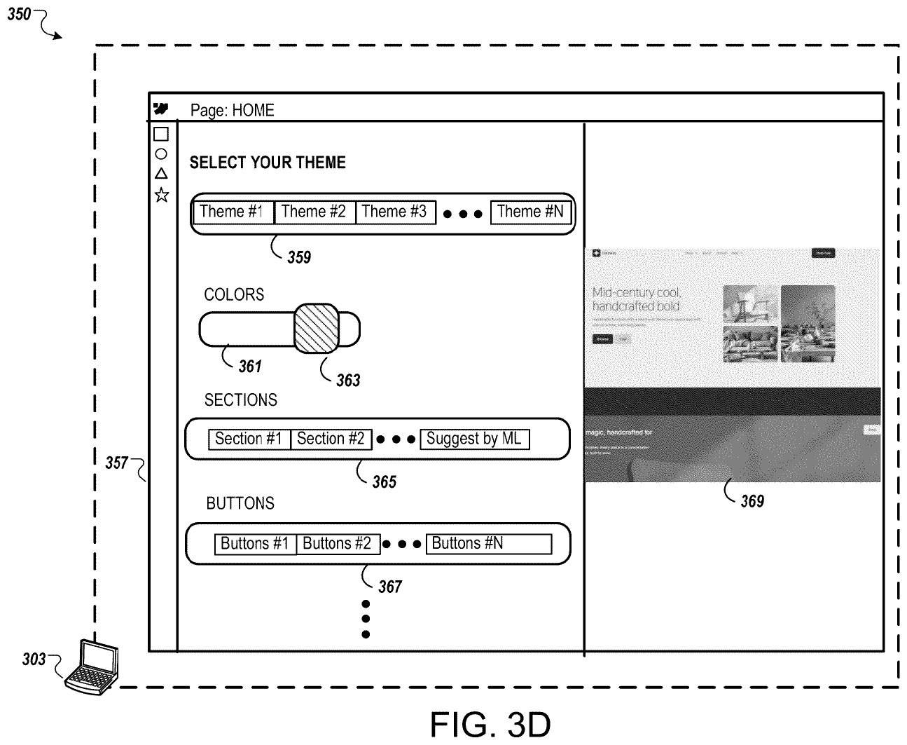

FIG. 1 illustrates an example of a technique for generating multiple webpages in response to a user request using one or more ML models and a CMS 120. In the example shown, the controller device 102 can display a home page, a starting page, or an application 152A for a controller or a user of the controller device 102. The application 152A includes a user interface 164 (e.g., a text-based chat interface) that enables the user to input requirements for generating one or more webpages in the input box 166. In some implementations, the user interface 164 can also present initial candidate themes or templates for the user to select, in addition to supporting free-form text input of requirements. Alternatively, or in combination, the user interface 164 may allow the user to specify further requirements for webpage generation by selecting or moving a toolbar, such as the number of pages to be generated, an overall theme, background colors or color schemes, a primary color palette, or other suitable parameters. This design enables application 152A to capture user requirements through both an open-ended, chatbot-like interface and a semi-guided interface that prompts the user to select from a predetermined set of choices specifying additional requirements. More details of the user interface 164 are described below in connection with FIGS. 3A-3D.

As shown in FIG. 1, the controller device 102 and the application 152A then interact with server(s) 110 to generate one or more webpages according to the requirement data specified by the user, either by the user input text or user selection as described above.

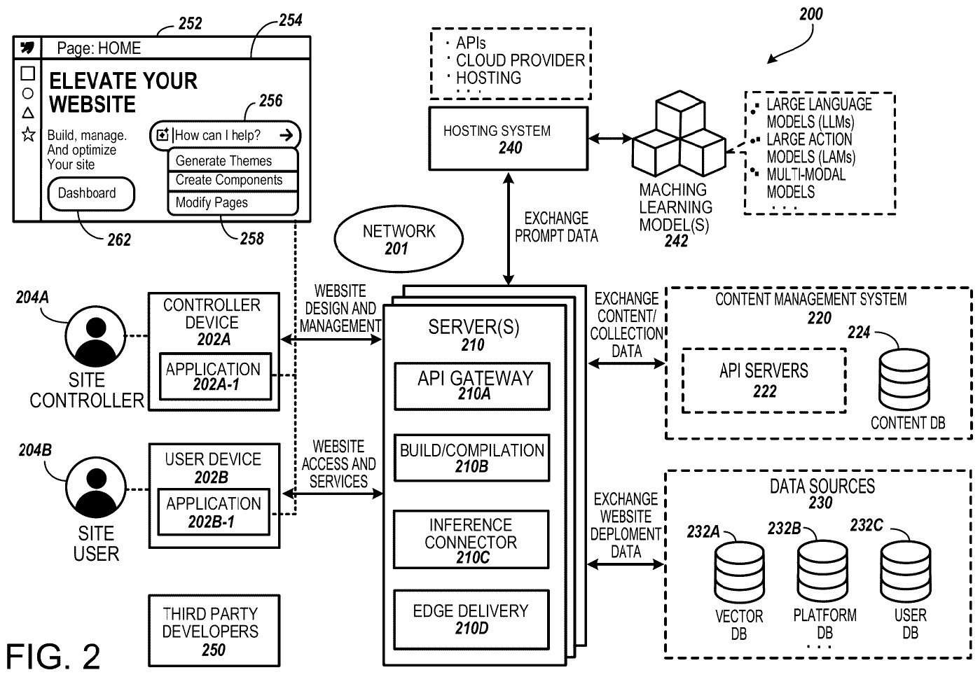

More specifically, in addition to the controller device 102, the system or platform described herein (e.g., the WEP shown in FIG. 2) includes one or more server(s) 110, a content management system (CMS) 120, data sources 130, and a hosting system 140. The hosting system 140 is further communicative coupled with one or more ML models, deployed on or remote to the hosting system 140. These elements implement backend processes (e.g., information retrieval, information refinement, prompt generation/submission, output processing, output refinement) relating to user actions on a software frontend and information presented responsive to these user actions.

For example, a user may request the generation of one or more webpages with a particular theme through the user interface application 152A. In this scenario, backend processes executed by the server(s) 110, the CMS 120, the data sources 130, and the hosting system 130 facilitate the retrieval of information responsive to the request. Such information may include one or more webpage templates and the corresponding section metadata associated with each template. The system then fuses the retrieved information with content generated by one or more ML models, where the content is produced based on prompt data that is tailored to the specific user request.

The system further ensures that the retrieved information is aligned not only with the user request but also with context data associated with the request, such as workspace context data, user historical data, and other relevant inputs. As a result, the information presented to the user is responsive (e.g., directly addressing the user's query), up-to-date (e.g., consistent with the knowledge base maintained by the underlying CMS), and contextually relevant (e.g., tailored to the workspace context or interface state). Likewise, the prompt data provided to the ML models is grounded in both the retrieved information and the contextual data, enabling the ML-generated content to be accurately and seamlessly inserted into the appropriate sections of the relevant webpages according to the section metadata.

In the example shown in FIG. 1, after the user finishes typing webpage generation requirements into the input box 166, the user may interact with one or more UI elements to transmit the requirement data to the server(s) 110. This can be done, for instance, by clicking a push button (not shown) or by pressing the “Enter” key on a keyboard. The system then processes the request for webpage generation in the backend, which may take from several seconds to a few minutes, and subsequently displays a next representation 152B of the application 152A.

The next representation 152B can present one or more candidate webpages generated by the backend process. It may also provide multiple user-interactive elements that allow the user to further tailor the generated webpages. For example, the user may select one candidate webpage from a set of candidate webpages provided from the server(s) 110, adjust specific features such as themes or color schemes, modify background or primary colors via sliders, or add, remove, and edit textual or visual content generated from ML models and/or fetched from the CMS.

Additionally, the next representation 152B can include a user action section 172 for collecting additional user inputs. For instance, the user may select one or more actions from a dropdown bar 174 within the user action section 172. These actions can include selecting, deselecting, updating, or regenerating textual or visual content using ML models, as well as modifying webpage templates and/or the corresponding section arrangements retrieved from the CMS. More details of the next representation 152B are described below in connection with FIG. 3D.

Referring back to the backend process, after the user completes inputting requirement data for generating one or more webpages, the controller device 102 transmits both the request data 104 and the context data 106 to the server(s) 110. The request data 104 can include the text-based user requirements entered in the input box 166, such as style preferences, themes, or desired structural elements. The context data 106 can include additional information that describes aspects of the workspace currently accessed by the user (e.g., the active page, selected UI elements, component hierarchy, or recent authoring actions). The context data 106 may also incorporate historical information associated with the user, including patterns inferred from prior webpage generation activities, or user-specific data maintained in a distributed multi-tenant database.

Upon receiving the request data 104 and context data 106, the server(s) 110 generate a query for retrieving relevant information from the CMS 120. This query can be refined through natural language processing techniques to improve accuracy, for example by correcting typographical errors, normalizing grammar, or disambiguating terms in the user request. The query is further conditioned using the context data 106 so that the results more closely reflect the user's current requirements or historical usage patterns.

The server(s) 110 then access content data (or content chunks) stored in the CMS 120 as well as supplemental data from data sources 130. Collectively, this retrieval process identifies a corpus of relevant webpage data 116. Such data may include one or more webpage templates along with their corresponding section metadata, which defines the structural arrangement of each webpage. The server(s) 110 evaluate semantic relevance between the generated query and the content stored in the CMS 120 by leveraging vector representations. Specifically, content in the CMS 120 is embedded in a vector feature space (via one or more vector databases included within the data sources 130), and the query is compared against these embeddings. Webpage content that satisfies a predefined semantic similarity threshold is included in the set of webpage data 116 to be retrieved. This semantic retrieval approach ensures that the system identifies and surfaces not just keyword matches, but conceptually aligned and up-to-date content. As the CMS 120 is continuously curated, the retrieval process minimizes reliance on outdated or deprecated materials and increases the likelihood that the generated webpages reflect current product features, branding, or policies.

In parallel with retrieval, the server(s) 110 generate prompt data 112 based on the request data 104, the context data 106, and, optionally, the retrieved webpage data 116 from the CMS 120 and/or data sources 130. The prompt data 112 provides structured instructions for downstream execution by the hosting system 140. These instructions may include: instructions for one or more ML models to generate text-based content for specific webpage sections, guidance for aligning generated text with semantic content derived from templates and section metadata, constraints for adapting newly generated text based on previously generated text to maintain consistency across multiple pages, and/or various formatting or styling requirements specified by the user or the webpage templates.

The hosting system 140 receives the prompt data 112 and executes one or more ML models 142 to generate raw output data 114. This raw output data 114 may include natural language text, structured markup, or other content elements corresponding to the section metadata of the target webpage templates. The raw output data 114 is then returned to the server(s) 110 for further post-processing.

During post-processing, the server(s) 110 fuse the raw output data 114 into the corresponding sections of the webpage templates to generate one or more candidate webpages. The fused results are converted into processed output data 108, a representation that is optimized for rendering on the controller device 102. The processed output data 108 includes both the content and the structural instructions necessary to display the candidate webpages within the next representation 152B of the application 152A. Once received and executed by the controller device 102, the processed output data 108 causes the controller device to render the candidate webpages and to expose user interaction capabilities (e.g., selecting, modifying, or regenerating webpage elements) thereby enabling iterative refinement of the generated webpages as described above.

The information retrieval techniques shown in FIG. 1 improve upon RAG-based pipelines involving static vector databases. ML systems that rely on such RAG-based pipelines typically embed free-form documents without regard to application schemas. Similarly, some CMS platforms typically store typed records without generating embeddings that preserve referential constraints or field semantics. In contrast, the techniques shown in FIG. 1 involve generating schema-aware content chunks and corresponding vector representations that explicitly preserve CMS configurations and limitations. Chunk boundaries and embedding metadata are aligned to collection schemas, field types, and cross-reference links (e.g., component IDs, locale variants, or gated fields) so that retrieved content can be injected into prompts and rendered back into the authoring environment without violating referential integrity.

This schema alignment discussed above improves performance in two ways. For instance, it increases retrieval precision by ensuring preference over chunks whose schema tags match the workspace context of application 152A. Further, it reduces post-retrieval repair work because the output data from the ML models 142 is constrained to data models specified by the CMS 120. This is distinct from implementing a standard RAG index with a CMS, which does not involve specific types of chunking and embedding that preserve field-level typing, relationship graphs, and policy constraints.

Moreover, RAG pipelines also tend to produce static indexes (e.g., embeddings computed once and reused until a full rebuild). Similarly, CMS platforms update content continuously without coordinating vector freshness. The system and techniques described within this disclosure address this capacity gap with a recursive, CMS-driven update loop that re-embeds only the affected chunks when schemas, features, or referenced records change, and advances version pointers so retrieval prefers up-to-date vectors.

In some implementations, CMS events (e.g., content publish, schema edit, feature flag change) trigger dependency resolution that identifies impacted chunks, recalculates embeddings, and atomically swaps index entries so the vector database reflects the current configuration without a global reindex. This architecture addresses a known limitation of static RAG, which answers that are accurate to their source but outdated or misaligned to a user's current configuration. As shown in FIG. 1, by ensuring that similarity searches are performed over a living corpus whose semantics align with the CMS 120, the resulting benefits include improved contextual relevance and enhanced responsiveness.

The interplay between schema-aware embeddings and the recursive CMS updates also yield various advantages at runtime. For instance, because vectors carry schema and version tags, the server(s) 110 can condition query refinement on the workspace context and select only those chunks whose schema/version signatures match the user's workspace context. This reduces false positives that some RAG systems would surface. Conversely, as the CMS 120 evolves (e.g., a component API changes), update loops ensure the same signatures steer retrieval away from superseded guidance without requiring manual curation. This closed-loop behavior informs how the server(s) 110 orchestrates retrieval and prompting under latency constraints and at multi-tenant scale. This behavior also depends on specific types of data transformations and index maintenance strategies that are specific to typed, evolving application schemas and their operational event streams.

FIG. 2 illustrates an example of a system 200 enabling a web experience platform (WEP) for enabling website development using one or more ML models. In general, the website development capabilities enable users to design digital experiences, ingest user-defined digital experience specifications, transform the user-defined digital experience specifications into deployable artifacts, and distribute resulting web experiences over a network. For example, the WEP may receive design-time input that specifies pages, components, styles, interactions, and content, compile or otherwise process that input (e.g., assistance from one or more ML models) into executable markup, code bundles, media, and metadata. The WEP may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality can be layered onto different phases of the website-development lifecycle without requiring structural changes to the underlying build, orchestration, or delivery services.

The WEP includes various computing and data elements, examples of which are shown in FIG. 2. These elements generally exchange data over network 201. Controller device 202A represents an authoring endpoint operated by a site controller. User device 202B represents a consumption endpoint operated by a site user. Additional third-party developer devices 250 can interact with extension tooling.

One or more server(s) 210 enable centralized functionality associated with the WEP. These server(s) 210 can correspond to the server 122 shown in FIG. 1. As such, server 122 can perform the functionality described with respect to server(s) 210. Server(s) 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP over network 201. Using the authoring application 202A-1, the site controller can generate, import, or modify design-time assets (e.g., page structures, component libraries, style sheets, interaction timelines, and data bindings) and submit corresponding save, build, or publish requests to server(s) 210. Controller device 202A may render the authoring application in a browser context, a native container, or another runtime environment, and can exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by server(s) 210. The user device 202B may load static pages, dynamic CMS-backed content, e-commerce flows, membership-gated resources, or localized variants, depending on how the site was configured by the controller. Interactions initiated from the user device 202B can result in access-and-or-interact website-deployment data being exchanged with server(s) 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane can surface reusable elements such as component 262, and a canvas or viewport can preview the evolving layout in real time. An ML interface 256 permits the site controller 204A to issue natural language prompts or other inputs to interact with one or more ML models 242 via hosting system 240. Interface 256 may be implemented in various ways, such as a chat panel, voice overlay, multimodal widget, among others. Responsive model output can drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

Server(s) 210 operate as the execution core of WEP, receiving network traffic from external actor devices, coordinating internal workflows, invoking machine-learning resources, and emitting deployable or runtime assets. Although depicted as a single logical block, server(s) 210 can be implemented as a co-located cluster, a distributed micro-service mesh, or a cloud-hosted arrangement that scales elastically with demand.

Further, server(s) 210 incorporate a set of software modules configured to cooperate through message queues, RPC calls, or other service-bus mechanisms. At a high-level API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchange with the hosting system 240. Edge delivery modules 210D stage static and dynamic resources for low-latency distribution. Each module may be containerized, serverless, or otherwise independently deployable, allowing updates to be rolled out without interrupting the WEP.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They can apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, then emit hashed asset bundles, pre-optimized image variants, framework-specific component libraries, and search-index manifests. A dependency graph may be used to identify pages or assets are invalidated by a change so that a full rebuild is avoided. Unchanged artifacts can also be linked from previous build versions. Output objects are written to a versioned S3-style bucket, tagged with a content hash and build-number metadata, and handed off to edge-delivery modules for global propagation.

Inference connector modules 210C assemble prompt payloads that can include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout can serve the new build to a percentage of traffic while the prior build remains active for the remainder. Edge workers can also execute JavaScript or WebAssembly to perform request-time tasks (e.g., cookie-based A/B routing, on-the-fly image resizing, or server-side rendering of personalized fragments before returning a response that is cached for subsequent requests).

The architecture of server(s) 210 enable various applications of ML models 242 in relation to different web development workflows accessible through the WEP. In some implementations, server(s) 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is then streamed back to the interface 252 for user review and approval. The edge delivery modules 210D pre-warm caches for the updated path, enabling publishing to be completed quickly (e.g., under a second).

In some implementations, server(s) 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and a, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, server(s) 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules then create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP. The system lets a site controller define collections, fields, and localized variants, then stores and surfaces that content so that build and runtime processes can merge it with design artifacts. During ML workflows prompts can be enriched with relevant collection entries or schema information. Model output can be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP (e.g., modules of server(s) 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes can insert or mutate content. Server(s) 210 also transmit events that orchestration modules can listen to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages can query on reference fields without loading entire collections. It also stores media metadata that edge delivery modules 210D can use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when ML models generate or modify content through the same APIs.

Data sources 230 provide a storage layer that underpins content retrieval, ML context, and runtime personalization for WEP. Databases included in the database sources 230 may sit outside the server(s) 210 so it can scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference, the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector can retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which can feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules can link the updated content to its deployment record. If the item is member-restricted, a policy pointer is stored in user database 232C so edge delivery modules can enforce access at request time. This coordinated flow ensures that ML prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests can include design fragments, CMS records, or visitor questions. Response payloads can contain generated code snippets, rewritten copy, layout suggestions, or operational guidance that the platform can apply without manual intervention.

Hosting system 240 integrates with the WEP through a set of network accessible endpoints that can be reached by direct API calls, by cloud provider private links, or by a customer managed hosting arrangement. The inference connector 210C authenticates each request with an API key, signs payloads, and posts them to an endpoint path that selects a specific model or model version. The hosting system 240 can reside in a public cloud region, in a dedicated tenancy, or in an on-premise cluster that meets data residency requirements. Configuration flags allow workspace administrators to choose among these connectivity modes without changing application code.

ML models 242 implement the inference logic that generates the information used by the WEP. The models can be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 can route traffic to a single model or to an ensemble of models depending on the prompt type and workspace policy.

ML models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to system 200 in an event format that preserves token order so the authoring canvas can display partial completions in real time.

As discussed above, system 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five-page marketing site for a coffee brand with warm colors and bold headings.” Application 202A-1 then sends the prompt to API gateway modules 210A over network 201. Inference connector modules 210C forward the prompt to hosting system 240 which relays it to ML models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A then pass that context to ML models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. ML models 242 analyze the prompt and return a step list that includes creating a draft collection item, assigning a release date, and triggering a publish event. The response also contains signed mutation requests that API servers 222 can execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the updated content appears exactly when the scheduled date arrives.

In some implementations, system 200 is configured to generate adaptive themes that evolve over time based on user behavior and preferences. For example, system 200 may utilize ML models 242 to provide continuous adaptation, which can ensure the long-term relevance and personalization of website themes. In some aspects, the ML models 242 for generating adaptive themes can include user inputs, presets or packs, prebuilt webpage sections, and prompts provided to a machine learning model. System 200 may also be configured to evolve at multiple levels to improve its theme generation capabilities.

For example, the evolution of presets can be based on updated industry trends, the evolution of prompts can be based on user behavior and preferences, or the evolution of an ML model itself can be based on making adjustments to achieve a desired performance. As another example, the evolution of prebuilt webpage sections can be based on adding new sections developed from industry trends or in response to user feedback. In some implementations, system 200 may employ a federated learning approach to improve its theme generation capabilities by learning from multiple users while maintaining individual user privacy. System 200 may also generate a continuously evolving and personalized website theme by adapting to user behavior, user feedback, and industry trends, all without the user having to manually update design elements to maintain relevance.

In some implementations, system 200 may generate a webpage design in response to one or more inputs provided by a user. For example, the site controller 204A may interact with the controller device 202A to provide an input, such as an image pack or a visual mood board. The controller device 202A may provide the input by selecting from one or more options presented within the designer interface 252. System 200 can then determine a theme from the provided input content and provide the determined theme to the one or more models 242.

The one or more ML models 242 can then provide a page, or a portion of a page design, as output. System 200 may further allow site controller 204A to review this output and prompt the one or more ML models 242 to iterate on the design, for example, by providing additional input or feedback on the generated page or portion. Accordingly, once the user is satisfied with the generated design, system 200 can provide the page or portion of the page to another system, such as a web development platform, for the webpage or website to be built, without the user having to manually create design specifications or write code, and preserving a feedback-driven workflow.

As described throughout, system 200 may provide a comprehensive ML-driven system for creating, managing, and evolving a complete design system for a website. System 200 can analyze user inputs, brand guidelines, and industry trends to establish core design principles for a website. System 200 may then generate a full design system that can include, for example, a typography hierarchy, color palettes, spacing and layout rules, component libraries, and responsive design guidelines, among others. In some aspects, user inputs and brand guidelines may be received through step-by-step intake forms. In other aspects, system 200 may provide presets or packs, such as prebuilt webpage sections, that are built based on influences from industry trends for a user to select. System 200 can generate a complete and coherent design system based on high-level user inputs, without the user having to manually define each design rule or create a component library from scratch, thereby streamlining the brand identity creation process.

In some implementations, system 200 can include one or more key features to perform specific web development tasks. For example, system 200 may utilize a generative adversarial network (GAN)-based module to generate unique visual assets. The visual assets can include, for example, on-brand icons, illustrations, or patterns. As another example, system 200 may provide an ML-style transfer engine that automatically adjusts images to fit the established design system. System 200 can additionally provide an ML-powered design consistency checker to assist in ongoing website maintenance by identifying and flagging inconsistencies. In some implementations, a user may interact with these features through a natural language interface, which allows non-designers to make informed design adjustments. System 200 can thereby make design generation and maintenance capabilities accessible to a wider range of users, without requiring the user to have specialized design skills or perform manual consistency checks.

In some implementations, system 200 provides an ML-based design consistency checker using the one or more ML models 242 to analyze design elements across a generated website. For example, a user may desire to check for design consistency as a web development task. In this example, the ML-based design consistency checker is configured to identify inconsistencies in design elements. The design elements can include, for example, color, typography, spacing, or other design aspects, among others. Upon identifying an inconsistency, system 200 may flag the potential issue and suggest one or more corrections to the user. In this way, system 200 assists in maintaining a cohesive visual identity over time, without the user having to manually inspect webpages for design deviations or possess expert knowledge of the established brand guidelines, thereby preserving the integrity of the design system.

In some implementations, system 200 provides frameworks that ensure consistency, scalability, and brand alignment through continuous evolution of a design system. For example, a user may request to have the design system updated as a web development task. In this example, the design system may evolve based on various data inputs, including user interactions, A/B testing results, emerging design trends, among others. As another example, design system evolution may further be based on other types of updates (e.g., user inputs, presets/packs, prebuilt webpage sections, ML prompts, ML model updates). In this example, system 200 maintains a relevant and effective design system over time, without requiring a user to manually track and implement changes based on performance data or industry trends, thereby preserving brand alignment in a dynamic environment.

As another example, the continuous evolution of the design system can be based on updates to one or more aspects of system 200. These aspects can include user inputs, presets or packs, prebuilt webpage sections, prompts provided to a machine learning model, or the model itself. System 200 can maintain a relevant and effective design system over time, all without requiring a user to manually track and implement changes based on performance data or industry trends, thereby preserving brand alignment in a dynamic environment. Other methods for the evolution of a design system are also possible.

FIGS. 3A-3D illustrates a sequence of example user interfaces 300, 315, 330, and 350 for generating one or more webpages using one or more ML models and a content management system. In this example, the webpage generation involves a data pipeline in which heterogeneous source content is indexed for semantic matching with vector features determined from user request data. Additionally, the system further implements a separate data pipeline that utilizes prompt data tailored based on user request data and context data as input to one or more ML models to generate output for populating webpages.

As shown in FIG. 3A, when a user of the controller device 303 initiates the described techniques for bulk webpage generation, the system can present a first user interface 300. On this interface, the controller device 303 may display a textual introduction section 305 that briefly guides the user through the initial step of webpage creation. For instance, the textual introduction section 305 may display a concise prompt such as “Select a way to get started.” The first user interface 300 can further display three options, each representing a different approach to generating multiple webpages.

As illustrated in FIG. 3A, the first option 307 enables the user to generate webpages with the assistance of ML models. In this option, the system incorporates RAG techniques to identify content data in the CMS based on semantic similarity. The content data may include one or more webpage templates, each associated with respective section metadata. A webpage template generally defines a structural framework for a page, e.g., a landing page template may include various sections such as a pricing section, a testimonial section, or other suitable pages. The section metadata specifies the arrangement and role of each section in the webpage templates. Once the webpage templates and section metadata are identified, the system triggers one or more ML models to generate tailored content using prompt data. The output data from the ML models is then populated into the corresponding sections of the template.

In some implementations, the CMS can provide webpage templates and section metadata using one or more content chunks labeled and stored in different categories in the CMS. In the context of webpage design, content chunks generally refer to modular units of information that can be independently authored, retrieved, updated, or recombined to assemble larger webpages. Each chunk may contain text, images, video, interactive elements, or a combination thereof, and may be tagged with semantic descriptors for efficient retrieval and reuse. For example, a content chunk could be a product description with accompanying media assets, a pre-formatted call-to-action banner, or a testimonial block with user ratings. By managing webpages at the chunk level, the system supports granular updates (e.g., refreshing pricing tables without regenerating entire templates), improves consistency across multiple pages, and allows dynamic adaptation to user context or personalization signals. It also improves the augmentation of content stored in the CMS since the system can generate various webpage templates by selecting, arranging, and organizing different content chunks according to semantic similarity with the user request data.

The first user interface 302 can also include a second option 309, which allows the user to directly use one or more webpage templates stored in the CMS. In this mode, the system does not invoke ML models for generating webpage content as described above under the first option 307. Instead, the system semantically matches content data (including content chunks) in the CMS with features identified in the user's request. The system may extract user request features using natural language processing techniques, RAG retrieval, or a combination of both. For instance, the system may modify user text in the request data to correct typos, and then generate vector embeddings of the user's input (captured through controller device 303). The system can then compare the vector embeddings of the user requests against vector embeddings of content data in the CMS to determine semantic similarity and retrieve information from the CMS that is above a threshold level of semantic similarity. This semantic retrieval process ensures that the system surfaces templates and content chunks most relevant to the user's request data, while leveraging the curated knowledge base of the CMS. That said, in some implementations, the system can also trigger ML models for content generation upon users'requests. As a result, users can start from robust, pre-defined templates that are already populated with semantically aligned content, reducing design effort and improving output quality.

Additionally, the first user interface 302 can provide a third option 311 that allows the user to build webpages entirely from scratch. Selecting this option presents the user with a blank site along with a set of design tools to aid in content creation and layout management. These tools can include, for example, a drag-and-drop editor for adding and rearranging sections, a real-time style editor for adjusting fonts, color palettes, and responsive breakpoints, media integration tools for embedding images, videos, or interactive widgets, or other suitable design tools. In some implementations, the user may also invoke intelligent assistants to suggest layouts or auto-populate sections based on minimal input. In some other implementations, the system can provide a coding interface so that the user can instruct the system requirements related to webpage generation using user-specified code.

In some cases, if the user specifies one or more requirements through the above-noted design tools, the system can trigger RAG retrieval of relevant information from the CMS, similar to the first option 307 and the second option 309. The retrieval process can incorporate context data associated with the user, such as workspace metadata, prior editing history, or project-level preferences. By fusing this context with user requests, the system can identify semantically similar content within the CMS and provide candidate sections or content chunks for integration into the blank site. In some implementations, the system can also trigger ML models for content generation upon users'requests. This hybrid approach enables expert users to exercise full creative control while still benefiting from the efficiency of context-aware retrieval and ML-assisted generation.

In some implementations, the system can provide one or more tools 302 on the sidebar of the first user interface 300, regardless of which option the user selects. The tools 302 may include functionality for uploading or inputting user-provided materials such as images, text, videos, or other media assets, which can then be incorporated into the generated webpages. In addition, the tools 302 can include an ML-based assistant that provides a chat-based interface to guide the user through the design process. This assistant can answer design-related questions, suggest appropriate templates or content chunks, recommend stylistic adjustments, or even propose section arrangements based on the user's expressed goals. By integrating these tools into the sidebar, the system ensures that users have continuous access to supportive functionality across all modes of webpage generation.

After the user selects the first option 307 to build webpages using ML techniques, the system can cause the controller device 303 to display a second user interface 315 for collecting detailed user request data associated with webpage generation. More specifically, the second user interface 315 can include a text-based guidance section 319 that provides a brief introduction to the next step in the creation process, ensuring that users are oriented toward providing the specific requirements needed for generating one or more webpages. For example, the guidance section 319 may display a concise phrase such as “Share more details about your site” or “Tell us what you'd like to create.”

The second user interface 315 can provide a user input box 321 that allows the user to enter free-form textual requirements. For instance, a user might specify: “Create a landing page for a new mobile app with sections that highlight technical features, and include a sign-up form for the new mobile app.” In some implementations, the second user interface 315 can obtain user requirement data by providing a step-by-step intake form, which may include a sequence of input boxes with brief guidance or questions for the user to fill out, or a sequence of multiple-choice items for user selection, or both.

In some implementations, the system supports multi-modal input, enabling users to supplement their textual requests with images, screenshots, videos, or audio clips, or other suitable multimodal media. For example, a restaurant owner could upload menu photos and a short promotional video to generate multiple webpages for the restaurant. As another example, a photographer might upload sample images to guide the design of their portfolio site. The system may also allow the user to specify structural constraints, such as the desired number of candidate webpages (e.g., “generate three versions of a landing page”) or the number of sections per page (e.g., “limit each page to four sections, including a testimonial section”). These flexible inputs enable the system to accommodate a wide range of user design preferences and functional requirements.

In addition, the second user interface 315 can provide a set of example texts 323 for the user to select or refine. These example texts may appear dynamically after the user enters initial requirements into the input box 321, offering quick suggestions that help the user clarify or expand their request. For example, if the user types “Create a product launch page,” the system may display example texts such as “Include a pricing table and FAQ,” “Add a video hero banner,” or “Highlight customer testimonials.”

In some implementations, the system can generate these example texts 323 by analyzing the user's input in combination with context data such as user historical behavior, workspace metadata, or recent actions within the interface. For instance, if a user frequently works on e-commerce projects, the system may prioritize suggestions such as “Add a product carousel” or “Include shopping cart integration.” Similarly, if the user's workspace metadata indicates collaboration with a marketing team, the example texts may include options like “Add a newsletter sign-up form” or “Embed social media feeds.” In some implementations, the example texts 323 can be pre-determined as a set of examples of tones or styles for user's selection regardless of the user specified requirements entered in the user input box 321. The user can select one of the predetermined example text that match the tone for webpages the user designs.

The second user interface 315 can also present a list of tools in a sidebar to assist the user during the design process, similar to the tools 302 described above. These tools may include features for uploading user-provided content (e.g., images, logos, videos), selecting from pre-designed content chunks, invoking an ML-based assistant that provides real-time design suggestions, or other suitable tools.

After the user finishes providing initial requirement data in the input box 321, the system can cause the controller device 303 to display a third user interface 330 for collecting additional user request data related to webpage generation. In particular, this interface may focus on capturing high-level preferences such as the overall theme or style of the webpages the user wishes to create.

The term “theme” described herein generally refers to the overarching design framework of a webpage, including layout, color schemes, tones, and typography, which together establish the visual identity or characteristics of the site. For example, a user may select a “modern business” theme characterized by minimalist layouts, sans-serif fonts, and neutral colors, or a “creative portfolio” theme featuring bold imagery, asymmetrical grids, and vibrant accent colors, or other features. The term style may be used or referred to interchangeably in the description. That said, in some implementations, the system offers the user to choose from one or more particular styles, which focus more on specific visual treatments applied to elements within a webpage, such as button shapes (rounded vs. sharp), heading fonts (elegant script vs. geometric sans-serif), or iconography (flat vs. skeuomorphic). In short, and for simplicity of description, a theme may refer to the higher-level overall look and feel of a webpage design, while a style refers to the finer details or specific variations that exist within a given theme.

The third user interface 330 may include a text-based guidance section 339 that introduces this step to the user, for instance, displaying a phrase such as “Define your style” or “Choose a theme to match your vision.” Additionally, the third user interface 330 can provide an interactive button that, when selected, offers more detailed information or examples illustrating the differences between themes and styles, and provides brief guidance on how to select/specify a theme or style for webpage generation using the system.

The third user interface 330 can also present various candidate options for the user to select in connection with webpage generation, in addition to the requirement data provided through the input box 321 in the second user interface 315 in FIG. 3B. These candidate options may include one or more initial themes, background color schemes, primary color schemes, tonal settings for textual content, or other suitable configuration options. For example, as shown in FIG. 3C, the third user interface 330 may include a first user-selectable item 341 (e.g., a dropdown list or other suitable lists) presenting a set of candidate themes such as “modern business,” “creative portfolio,” or “e-commerce store page.” Similarly, a second user-selectable item 343 may display one or more candidate color schemes for user selection, such as a monochrome palette, a pastel palette, a high-contrast palette, or other suitable color schemes. As another example, a third user-selectable item 345 may allow the user to specify candidate tone options for textual content, such as “professional,” “casual,” “friendly,” “technical,” or other suitable tones.

In some implementations, the third user interface 330 can further allow the user to request that ML models automatically suggest tones, color schemes, or theme variations based on the user's input requirements and, optionally, contextual data. Upon request, the system can generate respective prompt data for ML models for generating various variations of tones, color schemes, or theme variations. As described above, the context information may include section metadata (e.g., content type or structural roles), workspace metadata (e.g., project type or prior edits), or other relevant context data. For instance, if the system detects that the user is designing a product launch page within a marketing workspace, the ML model may suggest a bold, promotional tone and a vibrant color palette aligned with marketing requirements or goals.

Here, the system can determine these initial candidate options using a combination of historical user data and context data prior to processing the user request data received in the second user interface 315. As described above, historical user data may include prior user interactions with the interface, project preferences stored in the multi-tenant database, or recurring patterns observed in previous webpage designs created by the same user(s). Context data may include workspace metadata (e.g., project type, target audience, or branding constraints) or other suitable environment-specific metadata, as described above.

To generate the above-noted candidate options, the system may evaluate similarity between the vector features of the historical data or metadata and the vector features of content data or content chunks stored in the CMS. For example, if a user has previously generated multiple “portfolio” webpages with minimalist themes and light color palettes, the system may proactively suggest similar options as candidates in the third user interface 330. Notably, the retrieval and analysis of CMS content data occur before the system processes the new request data entered in the input box 321 of the second user interface 315. Accordingly, these candidate options may be prepared in advance and presented immediately when the third user interface 330 is displayed, ensuring a seamless user experience.

In some implementations, to efficiently retrieve content data stored in the CMS, the system can generate index data that stores keys linking each vector feature from its originating content data to one or more vector features determined from the request data. In some implementations, the vector features correspond to respective content chunks that are segmented according to specific design concepts or themes. Each chunk can carry modality tags and version identifiers, allowing the system or user to identify more current, authoritative material in response to a request for data.

After obtaining the user-specified input data through the second user interface 315 and the third user interface 330, the system processes the request in the backend to identify and retrieve content data from the CMS according to semantic similarity. The identified content data can include one or more webpage templates and their corresponding section metadata, as described above. Additionally, the system generates prompt data based on both the user request data and relevant context data. This prompt data is provided to one or more ML models, which generate output content designed to be fused with the content retrieved from the CMS. Depending on the complexity of the request and the size of the retrieved content, this backend process may take from a few seconds to a couple of minutes.

The one or more ML models can include multimodal ML models that are capable of processing prompt data combining multiple types of inputs (e.g., text, images, audio, and structured metadata). A typical multimodal ML model architecture may include a multimodal encoder that projects heterogeneous inputs into a shared latent space and a multimodal decoder that generates coherent outputs aligned with webpage requirements. For example, such a model might take as input textual user requests, uploaded images, and context metadata, and then output a webpage section containing formatted text paired with relevant images or other visual content. In some implementations, the ML models may also include large language models (LLMs) to generate natural language text and large action models (LAMs) to predict and orchestrate structural or layout-related actions in webpage design.

The system fuses the ML-generated output data with webpage templates retrieved from the CMS to populate one or more complete webpages. The number of populated webpages can be specified by the user as part of the request data. The system then transmits instruction data to the controller device 303 that, once executed, causes the device to display one or more of the generated webpages. In some cases, the system may produce multiple candidate representations of the same webpage. Each candidate representation is constructed by populating the pre-constructed templates with different candidate outputs from the ML models, thereby offering the user multiple design variations to choose from.

For example, and as shown in FIG. 3D, the controller device 303 can display a fourth user interface 350 that presents a representation of one of the populated webpages 369. The populated webpage 369 can include multiple sections, where the textual and visual content is either retrieved from the CMS (based on semantic similarity with the user request) or generated by one or more ML models, as previously described. Furthermore, the populated webpage 369 is rendered in a theme and/or style corresponding to the user's prior selections or textual requirements.

The fourth user interface 350 can also include a variety of interactive elements that allow the user to refine, adjust, or regenerate selected portions of the populated webpage 369. For example, the user may choose a new theme from multiple candidate themes displayed in a user-selectable item 359 (e.g., a dropdown list or carousel). Unlike the candidate themes presented earlier in the third user interface 330, these candidate themes in the user-selectable item 359 are generated dynamically based on the current user request data and additional context data transmitted from the controller device 303. The fourth user interface 350 may also include tools for color customization. For instance, a sliding color bar 361 with a slider 363 enabling adjustments to background and/or primary colors. Additionally, the user may refine specific sections of the webpage via a user-selectable item 365 or adjust visual details such as button styles through a user-selectable item 367. Other types of customization options can also be presented, such as font selectors, image replacement tools, accessibility adjustments, etc.

The controller device 303 transmits these user interactions or selections as second user request data to the server(s). The server(s) may then re-retrieve updated information from the CMS and/or re-generate content using one or more ML models. This enables iterative refinement, allowing the system to progressively update webpages based on user feedback until the desired design outcome is achieved.

The example interfaces shown in FIG. 3A-3D are presented for simplicity and clarity. Other arrangements, variations, and combinations of these interfaces are possible, including additional customization panels, multi-step wizards, or adaptive interfaces that dynamically adjust based on the user's design proficiency.

In some implementations, the system (or server) can further determine templates and design options based on aggregated user preferences collected across multiple controller devices. The system may receive preference data indicating template or style selections from multiple users, and the server can generate aggregate preference profiles based on this data. These aggregate profiles can then be used to update pre-constructed page templates. For example, the templates displayed in user-selectable item 341, user-selectable item 359, or both. This technique enables the system to tailor outputs based on aggregated user preference trends while preserving the privacy of individual users.

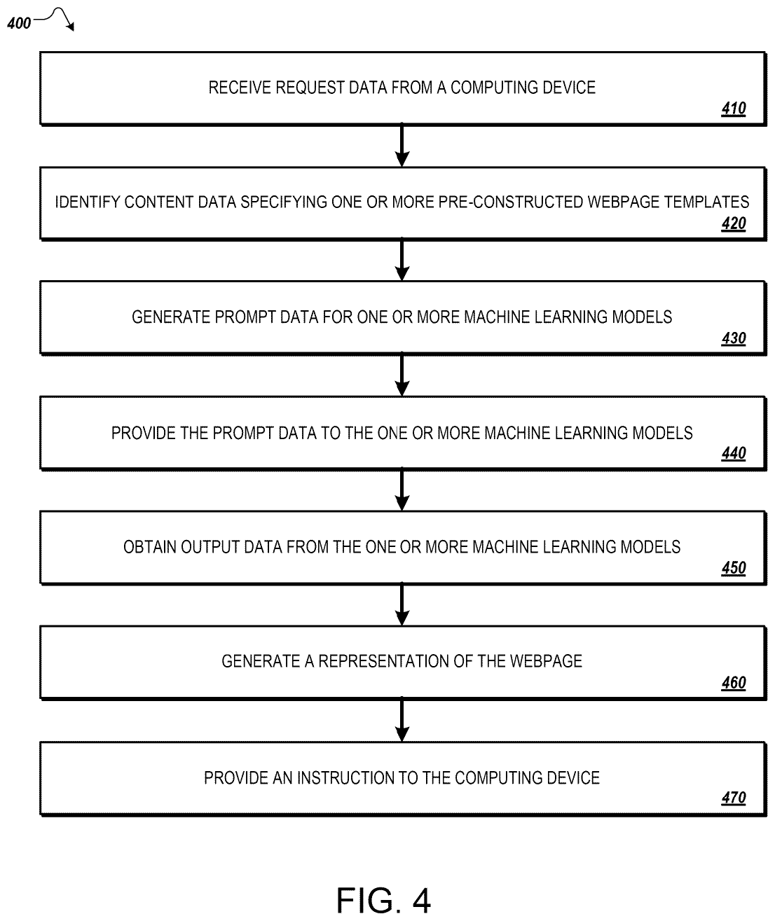

FIG. 4 illustrates a flow chart for an example process 400 for generating multiple webpages in response to a user request using one or more ML models and a content management system. The operations of the example process 400 can be performed by one or more systems, e.g., system 200 of FIG. 2 or one or more elements of system 200. The process 400 may be executed by system 200 further in relation to the technique shown in FIG. 1. For example, application 152A on controller device 102 transmits a user request data captured from input box 166 and context data describing the workspace context or other suitable context. The server(s) 110 can process the user request to retrieve webpage data 116 from CMS 120 and/or data sources 130 according to semantic relevance. The server(s) 110 can further generate one or more prompt data to be provided as input to one or more ML models 142 via the hosting system 140. The hosting system 140 can provide raw output data 114 generated by one or more ML models 142 to server(s) 110 to populate one or more webpages. The server(s) can merge the ML-generated content with the corresponding sections of one or more webpage templates based on the section metadata. The server(s) 110 can transmit instructions, including the processed output data 108, to the controller device 102, and once executed by the controller device 102, cause the controller device 102 to display one or more webpages generated in response to the user request data.

More specifically, process 400 includes receiving, by a server system and from a computing device, request data specifying one or more user requirements for generating a webpage (410). As described above, the user requirements may include structural preferences (e.g., the number of sections per page), thematic or stylistic preferences (e.g., “modern business” or “creative portfolio”), or content-related requirements (e.g., a pricing table, testimonial section, or embedded video), or other suitable requirements. In some implementations, the system can receive user requirements by presenting on the controller device a step-by-step intake form, e.g., one or more text input boxes and/or one or more multiple choice questions, as described above.

Process 400 further includes identifying content data by the server system based on the received user requirements (420). The content data can specify one or more pre-constructed page templates stored in a content management system, and for each pre-constructed page template, the corresponding section metadata that defines and organizes webpage content according to semantic similarity with the user requirements. More details related to the webpage templates and section metadata are described above.

To identify the relevant content data, the system embeds at least a portion of the request data into a query vector representation within an embedding space. The system then computes a respective semantic similarity score by determining the distance in the embedding space between the query vector representation and vector representations of content chunks segmented from a multimodal knowledge base associated with the content management system. The distance in the vector space can take various forms. For example, the system can define the distance as the Euclidean distance (also referred to as L2 norm), which corresponds to the straight-line distance between two points in a vector space. As another example, the system can define the distance as the L1 norm, which represents the sum of absolute differences along each coordinate axis. Based on these similarity scores, the system selects one or more content chunks as the content data from the CMS. For example, the system may select the content chunks with the highest similarity scores, or alternatively, select all content chunks that exceed a predefined threshold level of semantic similarity.

In some implementations, the one or more user requirements may relate to a theme for the webpage. A theme defines the overall look and feel, such as layout, typography, and color palette, of a webpage, as described above. For example, a theme may be “modern furniture” with clean layouts and neutral tones.

In some implementations, the theme can further specify a background color and a primary color for the webpage. For example, the background color sets the overall color background of all webpages, while the primary color sets the color for all textual content in the webpages. The background color and primary color can include light neutrals, dark palettes, color gradients, or other suitable color schemes. Additional details related to the background color and primary color are described above.

In some implementations, the system can generate a personalized website theme using multi-modal ML analysis in response to a request provided by a user. For example, a user may provide one or more inputs to the system to specify design preferences for generating a website theme. The inputs may be provided through a step-by-step intake form and can include various data types. The input types can include, for example, textual descriptions, voice recordings, or uploaded images that may function as a visual mood board, among others. The client device can process multi-modal inputs, transform them into a format suitable for receipt by an ML model, and transmit the data to a server system.

As another example, the system can integrate user-provided inputs with real-time industry trend data to ensure that the generated themes are both personalized and contemporarily relevant. In some respects, the system may present the user with a selection of presets or packs, where a pack can correspond to a collection of design elements such as color palettes, spacing rules, or typography styles that are based on current industry trends. The user may then select a desired pack from a selection menu or list to guide the ML model. Presets or packs may evolve over time based on emerging design trends, for example, by adding new color palettes or updating component styles. The system may generate a personalized and modern website theme by combining multi-modal user input with dynamic trend data, allowing a user to create a highly tailored website without needing to manually research design trends or possess advanced technical expertise.

Process 400 includes generating, by the server system, prompt data for one or more trained ML models (430). The prompt data includes one or more instructions for generating output data, including content for populating the one or more pre-constructed page templates based on the section metadata. In some implementations, the prompt data may incorporate or be derived from user request data, webpage templates, section metadata, context data (e.g., workspace or historical data), or content chunks retrieved from the CMS.

In some implementations, the output content generated for populating the page templates may include textual content such as headings, body text, product descriptions, or calls to action. In other cases, the content may also extend to other modalities, including images, videos, audios, icons, or even layout adjustments, depending on the role specified by the section metadata. For example, a “testimonial section” may be populated with user quotes, user images and/or videos, profile images, or other suitable content, while a “pricing section” may be filled with tiered descriptions and numerical data.

Process 400 includes providing, by the server system, the prompt data to the one or more trained ML models (440). The ML models process the prompt data to produce output content that can be fused with pre-constructed page templates in accordance with the section metadata, as described above.

In some implementations, one or more trained ML models can include a multimodal ML model, which includes a multimodal encoder and a multimodal decoder. The multimodal encoder is configured to integrate heterogeneous inputs (e.g., text, images, metadata) into a shared latent space, and the multimodal decoder is configured to generate outputs from the projected inputs in the shared latent space according to prompt requirements. In some implementations, the ML models may also include large language models (LLMs) for natural language generation, or large action models (LAMs) for predicting structural or layout-related actions, or both, as described above.

Process 400 includes obtaining, by the server system and from the one or more trained ML models, the output data (450). The output data may include text, images, layout suggestions, or other multimodal content generated in response to the prompt data, as described above.

In some implementations, the output data can specify a plurality of candidate outputs for a representation of the webpage. The system can generate multiple webpage representations by populating one or more pre-constructed page templates with the respective candidate outputs. Each representation offers a variation in structure, tone, or style, enabling the user to select the option that best aligns with their goals, as described above. For example, one candidate output may emphasize concise marketing copy with a bold color scheme, while another may generate more detailed descriptions paired with professional styling. Similarly, for a testimonial section, one candidate representation may highlight short quotes with large portrait images, whereas another may arrange longer narratives with smaller supporting visuals.

Process 400 further includes generating, by the server system and based on the output data, a representation of the webpage (460). The representation is created by populating one or more pre-constructed page templates with the ML-generated output data, ensuring that the final structure aligns with the corresponding section metadata.

Process 400 also includes providing, by the server system and to the computing device, an instruction responsive to the request data (470). When received and executed by the computing device, this instruction causes the computing device to render and display the generated webpage representation to the user.

In some implementations, the system can further allow the user to adjust the displayed webpage(s) iteratively. As described above, the server system can receive, from the computing device, second request data that specifies a user interaction with a targeted portion of the webpage representation. Based on the previously generated output data and the second request data, the server system can then retrieve new content data from the CMS and/or generate second prompt data for one or more trained ML models. This second prompt data can include additional instructions for refining or regenerating output data in response to the user's interaction. For example, a user may highlight a testimonial section and request “Make this more concise,” or adjust a color scheme slider to change the background color style, or other suitable user actions or feedback.

In some implementations, the server system can also collect preference data from multiple computing devices, where each device provides information indicating one or more user preferences. The server system can then generate aggregate user preference data by combining the collected preferences across users. Based on this aggregate preference data, the system may update one or more of the pre-constructed page templates. For instance, if a significant number of users consistently favor minimalist themes with light color palettes, the system may prioritize such templates in future suggestions or refine existing templates to better reflect those preferences or trends. This approach allows the system to evolve its template library in line with emerging user trends while maintaining the privacy of individual users, as described above.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (e.g., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing ML models can also include, for example, special-purpose hardware accelerator units for processing common and compute-intensive parts of ML training or production (e.g., inference, workloads).

ML models can be implemented and deployed using a ML framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification), or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

What is claimed is:

1. A computer-implemented method comprising:
receiving, by a server system and from a computing device, request data specifying one or more user requirements for generating a webpage;
identifying, by the server system and based on the one or more user requirements, content data specifying (i) one or more pre-constructed page templates from a content management system, and (ii) for each of the one or more pre-constructed page templates, corresponding section metadata that organizes webpage contents according to semantic similarity;
generating, by the server system, prompt data for one or more trained machine learning (ML) models, wherein the prompt data comprises one or more instructions for generating output data comprising content for populating the one or more pre-constructed page templates based on the section metadata;
providing, by the server system, the prompt data to the one or more trained ML models;
obtaining, by the server system and from the one or more trained ML models, the output data;
generating, by the server system and based on the output data, a representation of the webpage by populating the one or more pre-constructed page templates with the output data; and
providing, by the server system and to the computing device responsive to the request data, an instruction that, when received by the computing device, causes the computing device to display the representation.

2. The method of claim 1, wherein the content for populating the one or more pre-constructed page templates comprises textual content.

3. The method of claim 1, wherein the one or more user requirements comprises a theme for the webpage.

4. The method of claim 3, wherein the theme specifies a background color and a primary color for the webpage.

5. The method of claim 1, wherein identifying the content data comprises:
embedding a first portion of the request data into a query vector representation in an embedding space;
determining a respective semantic similarity score based on a respective distance in the embedding space between the query vector representation and a vector representation for each of content chunks segmented from a multi-modal knowledge base associated with the content management system; and
selecting one or more of the content chunks as the content data.

6. The method of claim 1, wherein the output data comprises textual data, image data, audio data, or video data.

7. The method of claim 1, wherein the one or more trained ML models comprise a multi-modal encoder and a multi-modal decoder.

8. The method of claim 1, wherein the one or more trained ML models comprise a large language model (LLM).

9. The method of claim 1, further comprising:
receiving, by the server system and from the computing device, a second request data specifying a user interaction with a targeting portion of the representation; and
generating, by the server system and based on (i) the output data and (ii) the second request data, second prompt data for the one or more trained ML models, wherein the second prompt data comprises one or more additional instructions for generating the output data based on the user interaction.

10. The method of claim 1, wherein:
the output data specifies a plurality of candidate outputs for the representation of the webpage; and
generating the representation of the webpage comprising generating a plurality of representations of the webpage, wherein each representation included in the plurality of representations of the webpage is generated by populating the one or more pre-constructed page templates with a corresponding candidate output included in the plurality of candidate outputs.

11. The method of claim 1, further comprising:
receiving, by the server system and from multiple computing devices, respective preference data indicating one or more user preferences of each of the multiple computing devices;
generating, by the server system, aggregate user preference data based on the one or more user preferences of each of the multiple computing devices; and
updating, by the server system and based on the aggregate user preference data, the one or more of the pre-constructed page templates.

12. A system comprising one or more computers and one or more storage devices storing instructions that, when executed by one or more computers, cause the one or more computers to perform respective operations, the operations comprising:
receiving, by a server system and from a computing device, request data specifying one or more user requirements for generating a webpage;
identifying, by the server system and based on the one or more user requirements, content data specifying (i) one or more pre-constructed page templates from a content management system, and (ii) for each of the one or more pre-constructed page templates, corresponding section metadata that organizes webpage contents according to semantic similarity;
generating, by the server system, prompt data for one or more trained machine learning (ML) models, wherein the prompt data comprises one or more instructions for generating output data comprising content for populating the one or more pre-constructed page templates based on the section metadata;
providing, by the server system, the prompt data to the one or more trained ML models;
obtaining, by the server system and from the one or more trained ML models, the output data;
generating, by the server system and based on the output data, a representation of the webpage by populating the one or more pre-constructed page templates with the output data; and
providing, by the server system and to the computing device responsive to the request data, an instruction that, when received by the computing device, causes the computing device to display the representation.

13. The system of claim 12, wherein the content for populating the one or more pre-constructed page templates comprises textual content.

14. The system of claim 12, wherein the one or more user requirements comprises a theme for the webpage.

15. The system of claim 12, wherein identifying the content data comprises:
embedding a first portion of the request data into a query vector representation in an embedding space;
determining a respective semantic similarity score based on a respective distance in the embedding space between the query vector representation and a vector representation for each of content chunks segmented from a multi-modal knowledge base associated with the content management system; and
selecting one or more of the content chunks as the content data.

16. One or more computer-readable storage media storing instructions that, when executed by one or more computers, cause the one or more computers to perform respective operations, the respective operations comprising:
receiving, by a server system and from a computing device, request data specifying one or more user requirements for generating a webpage;
identifying, by the server system and based on the one or more user requirements, content data specifying (i) one or more pre-constructed page templates from a content management system, and (ii) for each of the one or more pre-constructed page templates, corresponding section metadata that organizes webpage contents according to semantic similarity;
generating, by the server system, prompt data for one or more trained machine learning (ML) models, wherein the prompt data comprises one or more instructions for generating output data comprising content for populating the one or more pre-constructed page templates based on the section metadata;
providing, by the server system, the prompt data to the one or more trained ML models;
obtaining, by the server system and from the one or more trained ML models, the output data;
generating, by the server system and based on the output data, a representation of the webpage by populating the one or more pre-constructed page templates with the output data; and
providing, by the server system and to the computing device responsive to the request data, an instruction that, when received by the computing device, causes the computing device to display the representation.

17. The one or more computer-readable storage media of claim 16, wherein the content for populating the one or more pre-constructed page templates comprises textual content.

18. The one or more computer-readable storage media of claim 16, wherein the one or more user requirements comprises a theme for the webpage.

19. The one or more computer-readable storage media of claim 16, wherein identifying the content data comprises:
embedding a first portion of the request data into a query vector representation in an embedding space;
determining a respective semantic similarity score based on a respective distance in the embedding space between the query vector representation and a vector representation for each of content chunks segmented from a multi-modal knowledge base associated with the content management system; and
selecting one or more of the content chunks as the content data.

20. The one or more computer-readable storage media of claim 16, wherein:
the output data specifies a plurality of candidate outputs for the representation of the webpage; and
generating the representation of the webpage comprising generating a plurality of representations of the webpage, wherein each representation included in the plurality of representations of the webpage is generated by populating the one or more pre-constructed page templates with a corresponding candidate output included in the plurality of candidate outputs.
